(19) United States
(12) Patent Application Publication
(10) Pub. No.: US 2011/0291853 A1
(43) Pub. Date: Dec. 1, 2011

(54) Remote Shut Down of Offshore Wind Turbine

(76) Inventors: André Riesberg, Wallenhorst (DE); Markus Altenschulte, Spelle (DE)

(21) Appl. No.: 10/554,610

(22) PCT Filed: Jun. 11, 2003
(86) PCT No.: PCT/EP03/06108

§ 371 Date: Dec. 7, 2007

(51) Int. Cl. G08B 21/00; F03D 1/00; F03D 7/00; F03D 11/00

(52) U.S. Cl. 340/686.6; 416/31

(57) ABSTRACT

The method for initiating of shutting down a wind energy turbine comprises approaching the wind energy turbine by a vehicle like an aircraft, in particular a helicopter, a car or a boat, and initiating of shutting down the wind energy turbine by means of wireless remote command signal transmitted from the vehicle when the vehicle is spaced from the wind energy turbine by a predetermined distance. The wind energy turbine comprises a rotor having at least one rotor blade, a shut down control unit for shutting down the rotor, and a receiving unit operatively connected to the shut down control unit for receiving a wireless remote shut down command signal from a helicopter being spaced from the rotor a predetermined distance.

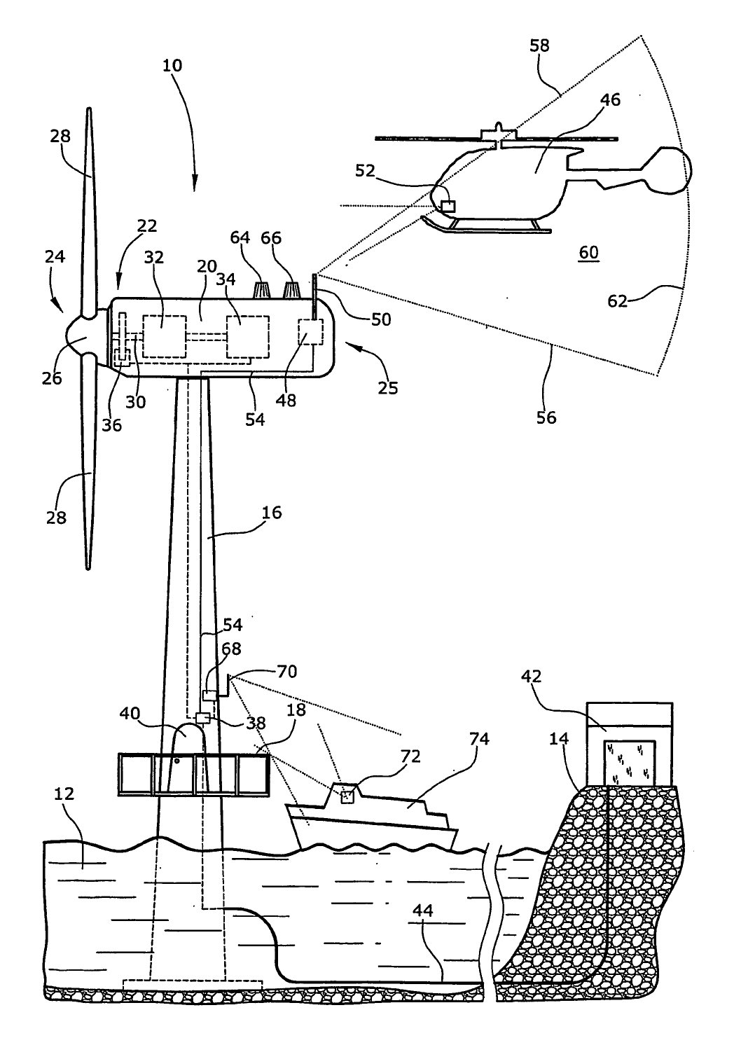

### BACKGROUND OF THE INVENTION

1. Field of the Invention

The present invention relates to a method for initiating of shutting down a wind energy turbine and, in particular, of an offshore wind energy turbine.

2. Description of Related Prior Art

It becomes more and more popular to transport maintenance persons to an offshore wind energy turbine by means of helicopters. Wind energy turbines are known (see e.g. DE-C-100 13 442 and EP-A-1 134 410) which are provided with platforms for landing purposes. As an alternative, the maintenance persons can be lowered from the helicopter so that landing of the helicopter is not necessary.

For safety reasons and in particular due to the turbulences of the wind stream behind the rotor, it is necessary that the wind energy turbine is shut down i.e. that the rotor stands still and is fixed.

Each wind energy turbine can be shut down by operating a switch or the like located within the tower at the bottom thereof or within a housing or building adjacent the tower. In case of offshore wind energy turbines shut down can be initiated from a control building located at the coast and being connected to the wind energy turbine by means of a wire.

Unfortunately, in case of disturbances of the connection between the control building and the wind energy turbine it is possible that the wind energy turbine cannot be shut down from remote. The only alternative given in such a situation is to forcely disconnect the wind energy turbine from the electric power network. However, disconnecting a wind energy turbine from the electric power network results in wear of the components (rotor, gear, generator, brake) of the wind energy turbine and a local disturbance of the power supply.

Accordingly, there is a need for an additional possibility for remotely initiating the shutting down of a wind energy turbine.

### SUMMARY OF THE INVENTION

The present invention provides a method for initiating of shutting down a wind energy turbine, in particular an offshore wind energy turbine, comprising the following steps:
approaching the wind energy turbine by a vehicle like an aircraft, a car or a boat in particular a helicopter, and
initiating of shutting down the wind energy turbine by means of a wireless remote command signal transmitted from the vehicle when the vehicle is spaced from the wind energy turbine by a predetermined distance.

A wind energy turbine, in particular an offshore wind energy turbine, which can be shut down according to this method comprises:
a shut down control unit for shutting down the rotor, and
a receiving unit operatively connected to the shut down control unit for receiving a wireless remote shut down command signal from at least one vehicle like an aircraft, in particular a helicopter, a car or a boat being spaced from the wind energy turbine a predetermined distance.

According to the invention, the shut down process for the wind energy turbine and, in particular, for stopping the rotor under control, disconnecting the generator from the electric power network at low rotational speed and breaking the rotor can be initiated by means of a wireless remote command signal. This wireless remote shut down command signal is transmitted according to the invention from a vehicle approaching the wind energy turbine. The wireless remote shut down command signal is received or detected by the wind energy turbine which is shut down thereafter. The invention will be described hereinbelow referring to the vehicle being a helicopter.

Accordingly, by means of the invention another possibility is provided for shutting down a wind energy turbine from remote. The invention provides for a method and a wind energy turbine in which the helicopter as such or a person in the helicopter can initiate the shutting down process.

Most preferably the wireless remote command signal is an electromagnetic signal which e.g. is selected from the group comprising a radio signal, IR signal, UV signal, and an optical signal. Basically, the wireless remote command signal should be encoded for safety reasons in order to prevent manipulations.

The kind of wireless remote command signal mentioned before in the first place will be transmitted from the helicopter by means of a corresponding transmitter which can be operated manually or automatically. In the latter case shutting down the wind energy turbine is automatically initiated when the helicopter is within a certain area spaced from the wind energy turbine so that the receiver of the wind energy turbine can receive the signal. As an alternative, transmission of the wireless remote command signal can be initiated manually when the helicopter is located within a predetermined range or area spaced from the wind energy turbine.

According to another aspect of the invention, the wireless remote shut down command signal can be an audio or video signal or both an audio and video signal. In this embodiment of the present invention the wind energy turbine is provided with a microphone or camera or both a microphone and camera for receiving these signals. For example a camera can detect by pattern recognition or the like helicopter within the acquisition area of the camera or can recognize the formation of shadow caused by the rotor of a helicopter. A microphone can detect the noise generated by a helicopter or another acoustic signal transmitted from the helicopter.

In other words all of the aforementioned examples relates to the detection of wireless remote signals which can be used for initiating of shutting down the wind energy turbine.

The wireless remote shut down command signal preferably can merely be detected and/or received when emitted from a area relatively located with respect to the wind energy turbine in a predetermined manner. For example and most preferably the shut down command signal can merely be detected and/or received when the helicopter is arranged behind the wind energy turbine, i.e. behind the rear end of the nacelle which rear end is opposite to the rotor. Accordingly, in this embodiment, merely if the helicopter is located within a certain azimuthal and elevational direction angle area facing the rear end of the nacelle, shut down of the wind energy turbine can be initiated.

According to a further aspect of the present invention different operating states of the wind energy turbine can be indicated by different signals, in particular light signals. For example, a first light signal is transmitted by the wind energy turbine under normal operation thereof while a second signal is transmitted when the wind energy turbine is shut down. The signals can be emitted by an emitter capable of emitting different signals or by several emitters each emitting a different signal. In particular, the first and second signals are emitted by at least one lamp located at the wind energy turbine, i.e. at the tower or the nacelle.

Instead of a helicopter as one example of an aircraft from which the shut down procedure of the wind energy turbine can be initiated, the vehicle can also be a boat or any type of car. It is possible that the shut down procedure can be initiated by remote command signals transmitted from different types of vehicles. For instance, in an offshore wind energy turbine shutting down can be initiated separately from or in combination with each other by both a helicopter and a boat. The same receiving unit can be used to receive a remote command signal from the helicopter and the boat. As an alternative, different receiving units can be provided at the same location of the wind energy turbine or at different locations thereof (i.e. nacelle for receiving the remote command signal from a helicopter and lower part of the tower for receiving the remote command signal from a boat). Moreover, the different receiving units can have receiving areas of different extensions or dimensions.

### BRIEF DESCRIPTION OF THE DRAWING

In the drawing there is shown a schematic side view of an offshore wind energy turbine and a helicopter approaching the wind energy turbine.

### DETAILED DESCRIPTION OF A PREFERRED EMBODIMENT

A preferred embodiment of the present invention is depicted in the drawing. In the drawing there is shown an offshore wind energy turbine 10 located on the sea 12 and a certain distance away from the coast 14. The wind energy turbine comprises a tower 16 having a gangway 18 which can be used as a dock for a ship (not shown) e.g. for maintenance purposes. On top of the tower 16 there is arranged a nacelle 20 having a front end 22 providing with a rotor 24, and an opposite rear end 25. The rotor 24 comprises a hub 26 and at least one rotor blade 28 extending radially from the hub 26. The hub 26 is mechanically connected to a rotor shaft 30 which in turn is connected to an input of a gear 32 having an output mechanically connected to a generator 34. A disc brake 36 is arranged at the rotor shaft 30. The nacelle 20 is rotatably mounted around a vertical axis.

Although in this embodiment the wind energy turbine has a rotor 24 rotatable around a horizontal axis, the present invention can also be used for wind energy turbines the rotor of which is rotatable about a vertical axis.

For maintenance purposes or due to other matters it is necessary that the wind energy turbine when under operation can be shut down in a controllable manner. Shutting down the wind energy turbine 10 means that the rotational movement of the rotor 24 will come to an end. For achieving the stopping of the rotor 24, the rotor blades 28 are adjusted until they are in a sailing position (feathered pitch). Due to this adjustment of the rotor blades 28, the rotational speed of the rotor 24 decreases. At a certain rather low rotational speed, the wind energy turbine 10 is disconnected from the electric power network. Thereafter, the disc brake 36 or the like brake for braking and fixing the rotor 24 is activated.

The aforementioned shut down procedure normally can be initiated by operating a shut down unit 38 wherein a corresponding switch normally is located closed to a maintenance door 40 at the lower end of the tower 16. In an offshore wind energy turbine the shut down unit 38 can also be operated from remote by a control unit building 42 located e.g. at the coast 14 and connected to the shut down unit 38 by a wire 44.

According to the invention, the shut down unit 38 can also be operated by means of a wireless remote command signal emitted or initiated by a helicopter 46. The wind energy turbine 10 is provided with a receiving unit 48 for detecting and/or receiving the wireless remote command signal. In this embodiment, the receiving unit 48 comprises an antenna 50 for receiving an electromagnetic signal emitted by an emitting unit 52 of the helicopter 46. The receiving unit 48 is connected to the shut down unit 38 by a wire 54. In this embodiment the receiving unit 48 and antenna 50 are located at the rear end 25 of the nacelle 20. However, also other locations for the receiving unit 48 and antenna 50 are possible. For example, these elements could also be located at the tower 16.

As being indicated by lines 56 and 58, the area within which the antenna 50 can receive the wireless remote command signal from the helicopter 46 is limited in azimuthal and elevational directions. This receiving area 60 in this embodiment is located behind the nacelle 20. This receiving area 60 is also limited concerning the distance which is shown by line 62. The location and extension of the receiving area 60 depends on the size of the wind energy turbine 10 and, in particular on the influences of the rotor 24 to the generation of any turbulences in the wind stream behind the wind energy turbine 10.

Limiting the receiving area 60 is useful in particular for safety reasons and for preventing manipulations. Safetyness of the helicopter and the persons therein has to be taken into consideration when the helicopter approaches the wind energy turbine 10 which at that time normally is under operation. On the other side limiting the receiving area 60 is also useful in order to prevent manipulations. Since it is guaranteed that shutting down of the wind energy turbine 10 can only be initiated when the emitter unit 52 is located within the receiving area 60.

Manipulations can further be prevented by transmitting an encoded wireless remote command signal. In this case the receiving unit 48 is provided with a decoder (not shown) for decoding the coded command signal which can be encoded by an encoder (not shown).

In order to indicate the current operational status of the wind energy turbine 10, two signal lights 64,66 are located on top of the nacelle 20. Alternative locations for these lights are anywhere at the nacelle 20 or at the tower 16. Both lights 64,66 emits an optical signal of different colours so that it can be indicated to the persons in the helicopter 46 whether or not the wind energy turbine 10 is in the shut down condition or is again in its normal operational condition e.g. after the maintenance work is completed. Instead of two lights it is also possible to merely have one light which is switched on or off in order to indicate the two different status of the wind energy turbine as mentioned before.

In the aforementioned description a wind energy turbine is disclosed which can be shut down upon receipt of a wireless remote command signal. It is clear that if necessary such a wind energy turbine can also be started by means of a wireless remote command signal. Accordingly, all the features and functions as well as structure described in connected with initiation of shutting down a wind energy turbine apply correspondingly to the initiation of starting a wind energy turbine.

In addition to the receiving unit 40 and associated antenna 50 or as an alternative hereto the wind energy turbine can be provided with another receiving unit 68 and antenna 70 the receiving area of which is directed to sea level for receiving from an emitting unit 72 of a boat 74 a remote wireless command signal for initiating the shutting down of the wind energy turbine 10. In this embodiment the antenna 70 of the receiving unit 68 or another sensitive element for detecting the approach of the boat (i.e. camera) is located at the bottom of the tower close to the door 40. However, the location of each of the receiving units is irrelevant for the invention as long as the receiving areas of a receiving unit is located and directed such that the approach of a vehicle (aircraft, helicopter, boat, car) can be automatically detected so as to initiate shut down of the wind energy turbine when the respective vehicle approaches the wind energy turbine or such that an approaching vehicle can transmit a remote wireless command signal which can be received by the receiving unit.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A method for initiating of shutting down a wind energy turbine, comprising
approaching the wind energy turbine (10) by a vehicle like an aircraft, in particular a helicopter (46), a car or a boat, and
initiating of shutting down the wind energy turbine (10) by means of wireless remote command signal transmitted from the vehicle when the vehicle is spaced from the wind energy turbine (10) by a predetermined distance.

2. The method according to claim 1, wherein the wireless remote command signal is an electromagnetic signal.

3. The method according to claim 2, wherein the electromagnetic signal is selected from the group comprising radio signal, IR signal, UV signal, and optical signal.

4. The method according to claim 1, wherein the wireless remote command signal is an audio or video signal or both an audio and video signal.

5. The method according to any one of claims 1 to 4, wherein the wireless remote command signal is coded.

6. The method according to any one of claims 1 to 5, wherein shutting down the wind energy turbine (10) can only be initiated by the wireless remote command signal, when the vehicle is within a predetermined area located relative to the wind energy turbine (10) in a predetermined azimuthal and/or elevational direction angle area (60).

7. The method according to claim 6, wherein the wind energy turbine (10) comprises a front end (22) provided with a rotor (24), and an opposite rear end (25) and wherein the predetermined area (60) is facing the rear end (25).

8. The method according to any one of claims 1 to 7, wherein the wind energy turbine (10) under operation transmits a first signal and, when shut down, transmits a second signal.

9. The method according to claim 8, wherein the first and second signals are optical signals of different colours.

10. The method according to claim 9, wherein the optical signals have different colours.

11. Wind energy turbine, in particular an offshore wind energy turbine, comprising
a rotor (24) having at least one rotor blade (28),
a shut down control unit (38) for shutting down the rotor (24), and
a receiving unit (48,50) operatively connected to the shut down control unit (38) for receiving a wireless remote shut down command signal from at least one vehicle like an aircraft, in particular a helicopter (46), a car or a boat being spaced from the wind energy turbine a predetermined distance.

12. The wind energy turbine according to claim 11, wherein the wireless remote command signal is an electromagnetic signal.

13. The wind energy turbine according to claim 11, wherein the electromagnetic signal is selected from the group comprising radio signal, IR signal, UV signal, and optical signal.

14. The wind energy turbine according to claim 11, wherein the wireless remote command signal is an audio or video signal or both an audio and video signal and wherein the receiving unit (48,50) comprising a microphone or a camera.

15. The wind energy turbine according to any one of claims 11 to 14, wherein the wireless remote command signal is coded and wherein the receiving unit (48,50) or the shut down control unit (38) comprises a decoder for decoding the coded wireless remote command signal.

16. The wind energy turbine according to any one of claims 11 to 15, wherein the wind energy turbine (10) under operation transmits a first signal and, when shut down, transmits a second signal.

17. The wind energy turbine according to claim 16, wherein lamps (64,66) for emitting different colours are provided.
